(19) United States
(12) Patent Application Publication
(10) Pub. No.: US 2012/0207214 A1
(43) Pub. Date: Aug. 16, 2012

(54) WEIGHTED PREDICTION PARAMETER ESTIMATION

(75) Inventors: Xiaosong Zhou, Campbell, CA (US); Douglas Scott Price, San Jose, CA (US); Yao-Chung Lin, Mountain View, CA (US); Hsi-Jung Wu, San Jose, CA (US)

(73) Assignee: APPLE INC., Cupertino, CA (US)

(21) Appl. No.: 13/077,803

(22) Filed: Mar. 31, 2011

Related U.S. Application Data
(60) Provisional application No. 61/441,961, filed on Feb. 11, 2011.

(51) Int. Cl. H04N 7/26

(52) U.S. Cl. 375/240.12; 375/E07.243

(57) ABSTRACT

Video coding systems incorporate techniques for deriving scalars W and/or O for use in weighted prediction. W represents a scaling factor and O represents an offset value. Given a frame of input video to be coded, a prediction match may be established one or more reference frames. The input frame may be parsed into a plurality of regions. Thereafter the scaling factor W and/or offset value O may be derived by developing a system of equations relating a predicted pixel to the pixel in the frame by the scaling factor W and/or offset value O. Equations within the system may be prioritized according to priority among regions, and scaling factor W and/or offset value O may be solved for. The scaling factor W and/or offset value O may be used during weighted prediction of the input frame.

### RELATED APPLICATION

This application claims benefit under 35 U.S.C. §119(e) of U.S. Provisional Application No. 61/441,961, filed Feb. 11, 2011, which is incorporated herein by reference in its entirety.

### BACKGROUND

The present invention relates to video coding and, in particular, to techniques for computing scale factors and offsets for use in weighted prediction.

Weighted prediction allows an encoder to specify the use of a scaling factor (w) and offset value (o) when performing motion compensation. Weighted prediction provides a significant coding benefit in performance in special cases—such as fade-to-black, fade-in, and cross-fade transitions. This includes implicit weighted prediction for B-frames and explicit weighted prediction for P-frames. Weighted prediction techniques have been codified in video coding standards such as ITU H.264.

Weighted prediction has been considered most effective for prepared video sequences where the fade effects are introduced into the sequences artificially, for example, by an editing operation. The inventors identified an opportunity to use weighted prediction in video conferencing applications where a continuous video sequence is presented for coding but the sequences exhibits brightness variations that arise due to variations in the captured video data. For example, operators often move about in proximity to lighting sources that affect the overall brightness of captured video data. Auto exposure controls at a camera may mitigate some brightness variations but not all. The inventors recognized a need for application of weighted prediction that can provide for efficient coding in light of such variations.

### BRIEF DESCRIPTION OF THE DRAWINGS

FIG. 1 is a functional block diagram of a videoconferencing system according to an embodiment of the present invention.

FIG. 2 is a simplified block diagram illustrating functional units involved in video coding, according to an embodiment of the present invention.

FIG. 3 is a simplified block diagram of functional units operable in a coding engine to code a pixel block, according to an embodiment of the present invention.

FIG. 4 illustrates a method for deriving values of W and O, according to an embodiment of the present invention.

FIG. 5 illustrates a method for deriving values of W and O, according to another embodiment of the present invention.

FIG. 6 illustrates a method for deriving values of W and O, according to a further embodiment of the present invention.

### DETAILED DESCRIPTION

Embodiments of the present invention provide video coding techniques for deriving scaling factors W and/or offset values O for use in weighted prediction. Given a frame of input video to be coded, a prediction match may be established with one or more reference frames. The input frame may be parsed into a plurality of regions. Thereafter the scaling factor W and/or offset value O may be derived by developing a system of equations relating a predicted pixel to the pixel in the frame by the scaling factor W and/or offset value O. Equations within the system may be prioritized according to priority among regions, and scaling factor W and/or offset value O may be solved for. The scaling factor W and/or offset value O may be used during weighted prediction of the input frame.

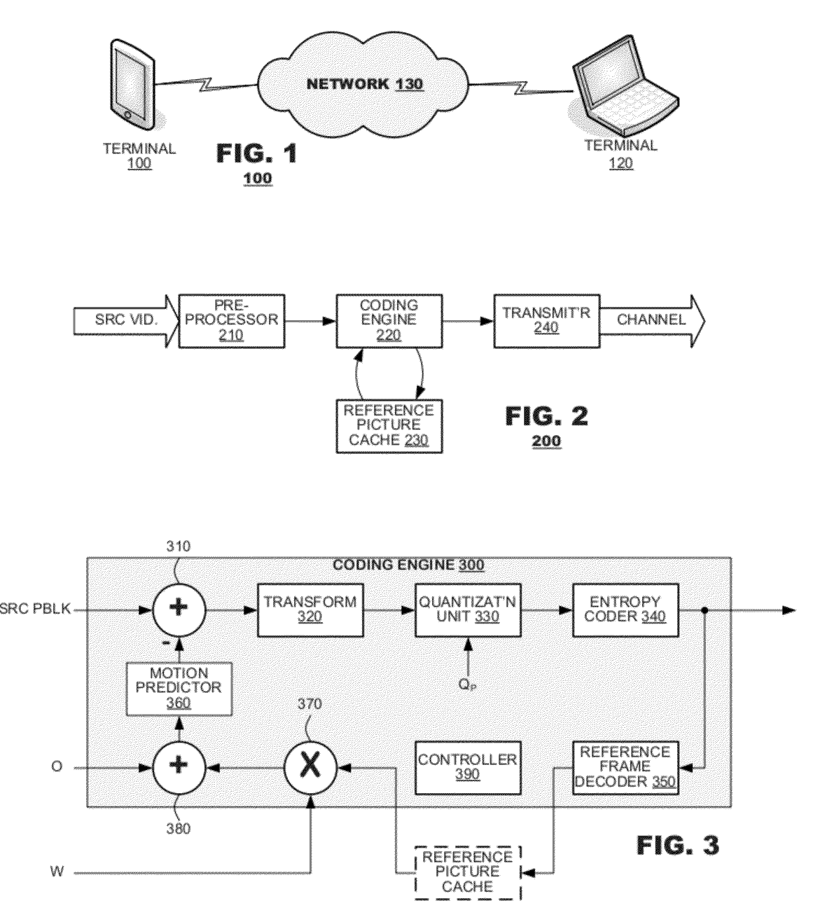

FIG. 1 is a functional block diagram of a videoconferencing system 100 according to an embodiment of the present invention. The videoconferencing system 100 may include a plurality of communication terminals 110, 120 provided in communication with each other via a communication network 130. The terminals 110, 120 may include respective video cameras, microphones, displays and speakers (not shown) to capture audio/video data at a near-end location and render audio/video data delivered to the respective terminal 110, 120 from a far-end location. The terminals 110, 120 also may include respective user input capture device(s), including touch screen, buttons and other devices to capture user input. Each terminal 110, 120 may include a processor and related memory to execute program instructions representing the terminal's operating system, user interface and video coder and decoder units and network communication equipment including modems for communication with a network.

The communication network 130 may provide communication channels between the respective terminals via wired or wireless communication networks, for example, the communication services provided by packet-based Internet or mobile communication networks (e.g., 3G and 4G wireless networks). Although only two terminals are described in detail, the videoconferencing system 100 may include additional terminals provided in mutual communication for multipoint videoconferences.

FIG. 2 is a simplified block diagram illustrating functional units involved in video coding, according to an embodiment of the present invention. The video coder 200 may include a pre-processor unit 210, a coding engine 220, a reference picture cache 230 and a transmitter 240. The pre-processor 210 may receive a source video sequence to be coded and may perform various processing operations on the source video to condition it for coding. The coding engine 220 may code the source video data by motion-predictive coding techniques to reduce the data rate of the source video so that it may be transmitted. The coding engine 220 further may decode coded video of reference frames, which may be stored in the reference picture cache 230 for use in coding later-received video. The transmitter 240 may format coded video data for transmission over the network.

In an embodiment, the pre-processor may parse individual frames of video data into pixel blocks (often, 16×16 or 8×8 blocks of pixel data within frames). The pre-processor further may apply filtering to the video data to condition it for coding by applying, for example, de-noising filters, sharpening filters, smoothing filters, bilateral filters and the like that may be applied dynamically to the source video based on characteristics observed within the video. The pre-processor 210 further may apply brightness control that normalizes brightness variations that may occur in input video.

The coding engine 220, in an embodiment, may be a functional unit that codes data by motion-predictive coding techniques to exploit spatial and/or temporal redundancies therein. The coding engine 220 may output a coded video data stream that consumes lower bandwidth than the source video data stream. The coded video data may comply with a predetermined coding protocol to enable a decoder (not shown) to decode the coded video data. Exemplary protocols may include the H.263, H.264 and/or MPEG families of coding standards.

In an embodiment, the transmitter 240 may format the coded data for transmission over the channel. The transmitter 240 may include buffer memory (not shown) to store the coded video data prior to transmission. The transmitter 240 further may receive and buffer data from other sources, such as audio coders (not shown), as well as administrative data to be conveyed to the decoder.

FIG. 3 is a simplified block diagram of functional units operable in a coding engine 300 to code a pixel block, according to an embodiment of the present invention. The coding engine 300 may include a subtractor 310, transform unit 320, quantization unit 330 and entropy coder 340 to generate coded video data from source video. The coding engine 300 further may include a reference frame decoder 350 to decode coded video data of reference frame(s), which may be stored to the reference picture cache. The coding engine 300 also may include a motion predictor 360, scalar 370 and adder 380 to generate predicted pixel block content to be used by the subtractor.

To code an input pixel block predictively, the motion predictor 360 may generate a predicted pixel block and output the predicted pixel block data to the subtractor 310. The subtractor 310 may generate data representing a difference between the source pixel block and predicted pixel block. The subtractor 310 may operate on a pixel-by-pixel basis, developing residuals at each pixel position over the pixel block. If a given pixel block is to be coded non-predictively, then the motion predictor 360 will not generate a predicted pixel block and the subtractor 310 may output pixel residuals that are the same as the source pixel data.

The transform unit 320 may convert the pixel block data output by the subtractor 310 into an array of transform coefficients, such as by a discrete cosine transform (DCT) process or a wavelet transform. Typically, the number of transform coefficients generated therefrom will be the same as the number of pixels provided to the transform unit 320. Thus, an 8×8, 8×16 or 16×16 block of pixel data may be transformed to 8×8, 8×16 or 16×16 blocks of coefficient data. The quantizer unit 330 may quantize (divide) each transform coefficient of block by a quantization parameter Qp. In many circumstances, low amplitude coefficients may be truncated to zero. The entropy coder 340 may code the quantized coefficient data by run-value coding, run-length coding or the like. Data from the entropy coder may be output to the channel as coded video data of the pixel block.

The reference frame decoder 350 may decode pixel blocks of reference frames and assemble decoded data for such frames. Although not shown in FIG. 3, the reference frame decoder 350 may perform operations that invert the entropy coding 340, quantization 330, transformation 320 and prediction 310 performed by the coding engine. Thus, the reference frame decoder 350 may generate a recovered frame that will have the same content as will be obtained by a decoder (not shown) when it decodes the reference frame. Decoded reference frames may be stored in the reference picture cache

The motion predictor 360 may search among the reference picture cache for stored decoded frame data that exhibits strong correlation with the source pixel block. When the motion predictor 360 finds an appropriate prediction reference for the source pixel block, it may generate motion vector data (MVs) that may be output to the decoder as part of the coded video data stream. The motion predictor 360 may retrieve a reference pixel block from the reference cache and output to subtractor 310. In so doing, the scalar 370 may scale the pixel data of the reference picture block by a scale factor w, which may have unity gain (w=1) in appropriate circumstances. Similarly, the adder 380 may add an offset O to the scaled data. The offset may be zero or have a negative value in appropriate circumstances.

The scalar 370 and adder 380, therefore, may cooperate to support weighted prediction in which a predicted pixel block is generated as:

P_{PRED}(i,j)=W*P_{REF}(i,j)+O, where Eq. 1

P_{PRED}(i,j) represents pixel values of a predicted pixel block input to the subtractor 310, P_{REF}(i,j) represents pixel values of a pixel block extracted from a reference picture cache according to the motion predictor, W represents the scale factor applied at scalar 370, and O represents the offset applied at adder 380.

In an embodiment, the scaling factor W and offset O values may be used for all reference pixel blocks extracted from a common frame in the reference picture cache. The scaling factor W and offset values O may be provided to the coding engine 300 once per frame or once per slice.

The coding engine 300 further may include a controller 390 to manage coding of the source video, including estimation of distortion and selection of a final coding mode for use in coding video.

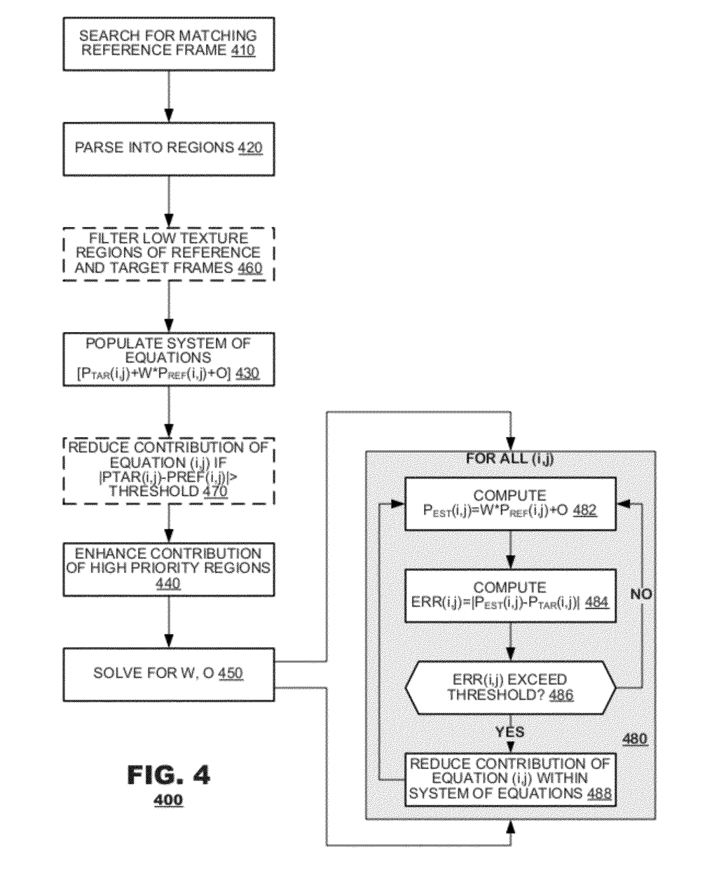

FIG. 4 illustrates a method 400 for deriving values of W and O, according to an embodiment of the present invention. In this embodiment, W and O may be derived for a common frame of video data. The method may begin by searching for a decoded reference frame that correlates to the input frame (box 410). Thereafter, the method may parse the input frame and reference frame into a plurality of regions (box 420). The frame may be parsed into pixel blocks of a predetermined size, for example, blocks of 32×32, 16×16 or 8×8 pixels. Alternatively, the frame may be parsed into regions such as foreground or background or into other visual elements (e.g., slices, video objects or other partitions) based on image content and further parsed into pixel blocks. For each pixel in the input frame, the method 400 may populate a system of equations having the form:

P_{TAR}(i,j)=W*P_{REF}(i,j)+O, where Eq. 2

P_{TAR}(i,j) represents a value of a pixel at location (i,j) in a target frame, P_{REF}(i,j) represents a value of a pixel at location (i,j) in a reference frame, W represents a scaling factor to be applied in weighted prediction, and O represents an offset value to be applied in weighted prediction (box 430). The values W and O eventually will be calculated in this system of equations. The method may supplement the system of equations by identifying regions having relatively high priority and preferentially weighting equations corresponding to those regions (box 440). High priority regions, by way of example, may be identified as regions having relatively low texture, regions toward the center of the image or regions that exhibit high temporal stability. The method 400 then may solve for W and O using the system of equations (box 450).

During operation of boxes 420-440, the method may create an over-determined system of equations, meaning it has more equations than unknowns. The method may solve for W and O using statistical estimation techniques. For example, the values of W and O may be derived as values that minimize mean squared error between the target pixel values that would be computed via Eq. 2 and the actual target pixel values that occur in the source pixel block. In another example, the values of W and O may be derived as values that minimize transform energy of prediction residuals generated between the target pixel values that would be computed via Eq. 2 and source blocks—when those residuals are coded via discrete cosine transforms, wavelet transforms, Hadamard transforms and the like. Once derived, the values of W and O may be used in the coding engine for use in weighted prediction during coding of pixel blocks.

In practice, if the motion estimation search (box 410) identifies non-zero motion, Eq. 2 will proceed as P_{TAR}(i,j)=W*P_{REF}(i−mvₓ,j−mv_{y})+O where mvₓ and mv_{y} are components of a motion vector identified in the motion estimation search.

In an embodiment, the method may operate as a pre-processing stage of operation before substantive coding and block-based motion estimation occurs. The W and O may be used for all coded blocks obtained by the coding engine.

The method of FIG. 4 may be extended to improve performance of the operations at boxes 410-450. For example, in one embodiment, before population of the system of equations, the target and reference frames each may be subject to denoising filtering in areas of low texture (box 460). In this manner, contribution of any noise components that might be present in the frames will be minimized.

In another embodiment, prior to computation of W and O, the method may reduce contribution, within the system of equations, of any equation for which the differences between the target pixel and its associated reference pixel exceeds a predetermined threshold (box 470). The threshold may vary based on an overall correlation factor identifying a degree of correlation between the target frame and the reference frame. In an embodiment, an equation may be removed entirely from the system of equations when the threshold is exceeded.

In a further embodiment, computation of W and O may be performed through an iterative operation (box 480). For example, after computation of W and O, the method may compute an estimated value of each target pixel through application of the scaling factor W and offset O to the corresponding reference pixel (e.g., P_{EST}(i,j)=W*P_{REF}(i,j)+O) (box 482). Thereafter, the method 400 may compute an error by comparison of the estimated target pixel value to the actual value of the target pixel (box 484). The method may compare the error value to a threshold. The threshold may vary based on a value representing a difference between the target pixels and the estimated pixels taken across the entire frame (box 486). If the error value exceeds a threshold, then the method may reduce contribution of the equation corresponding to the target pixel from the system of equations (box 488) or it may be removed entirely. The method may advance to box 450 to solve for W and O again. The operation of box 480 may be repeated over several iterations as desired.

The coding of each region has an associated cost due to the cost of encoding separate W and O parameters as well as other overhead. In an embodiment, the method may operate over a subset of regions based on an expected cost of coding the frame. The method also may determine how many regions should be made subject to the method 400 based on the expected coding cost, estimated benefit of using extra partitions and/or the current bit-rate of the coded video stream.

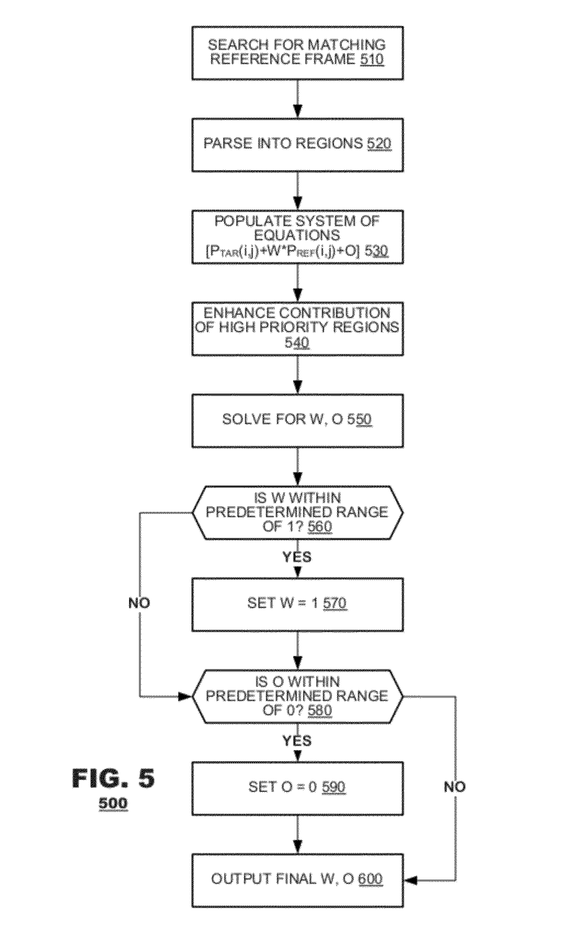

FIG. 5 illustrates a method 500 according to an embodiment of the present invention. Given an input frame, the method 500 may search for a decoded reference frame that correlates to the input frame (box 510). The method 500 may parse the input frame and reference frame into a plurality of regions (box 520). Again, the frame may be parsed into pixel blocks of a predetermined size, for example, blocks of 32×32, 16×16 or 8×8 pixels. Optionally, the frame may be parsed into regions such as foreground or background or into other visual elements (e.g., slices, video objects or other partitions) based on image content. The method 500 may populate a system of equations having the form of Eq. 2 (box 530). The method 500 may supplement the system of equations by weighting equations in regions having relatively high priority (box 540). Thereafter, the method 500 may solve for W and O using the system of equations (box 550).

Again, during operation of boxes 520-540, the method 500 may create an over-determined system of equations. The method 500 may solve for W and O using statistical estimation techniques. For example, the values of W and O may be derived as values that minimize mean squared error between the target pixel values that would be computed via Eq. 2 and the actual target pixel values that occur in the source pixel block. In another example, the values of W and O may be derived as values that minimize transform energy of prediction residuals generated between the target pixel values that would be computed via Eq. 2 and source blocks—when those residuals are coded via discrete cosine transforms, wavelet transforms, Hadamard transforms and the like. Once derived, the values of W and O may be used in the coding engine for use in weighted prediction during coding of pixel blocks.

In practice, if the motion estimation search (box 510) identifies non-zero motion, Eq. 2 will proceed as P_{TAR}(i,j)=W*P_{REF}(i−mvₓ,j−mv_{y})+O where mvₓ and mv_{y} are components of a motion vector identified in the motion estimation search.

In an embodiment, the method 500 may operate as a pre-processing stage of operation before substantive coding and block-based motion estimation occurs. The W and O may be used for all coded blocks obtained by the coding engine.

The method of FIG. 5 may be extended to improve performance of the operations at boxes 510-550. For example, in one embodiment, the method 500 may determine if W is within a predetermined range of the value 1 (unity gain) (box 560). If so, the method may set W to 1 (box 570). In another embodiment, the method 500 may determine of O is within a predetermine range of the value 0 (no offset) (box 580). If so, the method may set O to 0 (zero) (box 590). In either embodiment (or when both are used), the method may output W, O to the coding engine (box 600).

As in the embodiment of FIG. 4, the FIG. 5 method may reduce contributions or remove from the system of equations regions and/or blocks either by an a priori analysis or by iteration (step not shown). At some point in operation, the system of equations may represent a limited number of regions from which to solve for W and O. In this embodiment, the method may determine how many discrete regions are represented in the system of equations. If the number of regions is lower than a threshold number, the method may set W to unity and O to zero. The threshold number may be set as an absolute number of regions identified from a source image or a percentage of the initial number of regions identified from the source image.

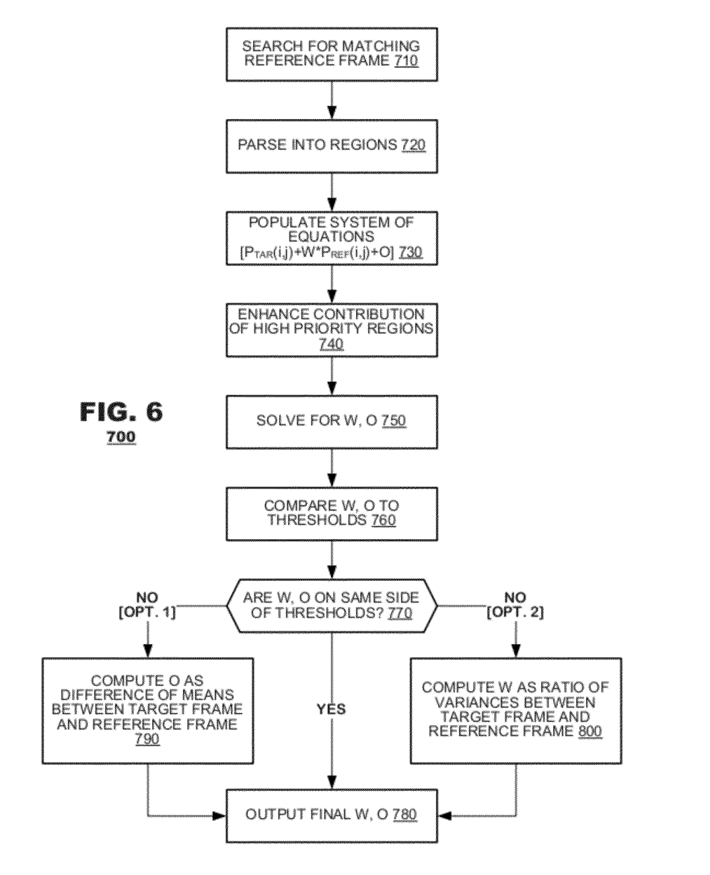

FIG. 6 illustrates a method 700 according to another embodiment of the present invention. Given an input frame, the method may search for a decoded reference frame that correlates to the input frame (box 710). The method may parse the input frame and reference frame into a plurality of regions (box 720). Again, the frame may be parsed into pixel blocks of a predetermined size, for example, blocks of 32×32, 16×16 or 8×8 pixels. Optionally, the frame may be parsed into regions such as foreground or background or into other visual elements (e.g., slices, video objects or other partitions) based on image content. The method may populate a system of equations having the form of Eq. 1 (box 730). The method may supplement the system of equations by weighting equations in regions having relatively low texture (box 740). The method may solve for W and O using the system of equations (box 750).

Again, during operation of boxes 720-740, the method 700 may create an over-determined system of equations. The method 700 may solve for W and O using statistical estimation techniques. For example, the values of W and O may be derived as values that minimize mean squared error between the target pixel values that would be computed via Eq. 1 and the actual target pixel values that occur in the source pixel block. In another example, the values of W and O may be derived as values that minimize transform energy of prediction residuals generated between the target pixel values that would be computed via Eq. 2 and source blocks—when those residuals are coded via discrete cosine transforms, wavelet transforms, Hadamard transforms and the like. Once derived, the values of W and O may be used in the coding engine for use in weighted prediction during coding of pixel blocks.

The method of FIG. 6 may be extended to improve performance of the operations at boxes 710-750. For example, in an embodiment, the method may compare the values of W and O obtained for the current target frame to predetermined thresholds (box 760). For example, the method 700 may determine whether W is greater than or less than unity (W>1) and whether O is greater than or less than zero. The method 700 further may determine whether the values of W and O are on the same “side” as these thresholds (box 770), for example, if W and O both are greater than their respective thresholds or both less than their thresholds. If W and O both are on the same side as their thresholds, the method 700 may output the computed values of W and O to the encoder (box 780).

If W and O are not on the same sides as their thresholds, then in a first embodiment, the value of W may be taken as valid but O may be recomputed using sources outside the domain of the system of equations. For example, O may be computed as a difference of mean pixel values of the target frame and reference frame respectively (O=AVG_{TAR}—AVG_{REF}) (box 790). In another embodiment, the value of O may be taken as valid but W may be recomputed using sources outside the domain of the system of equations. For example, W may be computed as a ratio of variances between the target frame and the reference frame (W=VAR_{TAR}/VAR_{REF}) (box 800). Thereafter, the values of W and O may be taken as valid and output to the coding engine (box 780).

In another embodiment (not shown), if W and O are on different sides of the thresholds, the method may revise both values. It may calculate W first as W=VAR_{TAR}/VAR_{REF} and thereafter calculate O based on the newly calculated W value as O=AVG_{TAR}−(W*AVG_{REF}).

The foregoing discussion identifies functional blocks that may be used in video coding systems constructed according to various embodiments of the present invention. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system, in which the blocks may be provided as separate elements of a computer program. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, the functional blocks described herein need not be provided as separate units. For example, although FIGS. 2-3 illustrate the components of video coders as separate units, in one or more embodiments, some or all of them may be integrated and they need not be separate units. Such implementation details are immaterial to the operation of the present invention unless otherwise noted above.

Further, the figures illustrated herein have provided only so much detail as necessary to present the subject matter of the present invention. In practice, video coders typically will include functional units in addition to those described herein, including audio processing systems, buffers to store data throughout the coding pipelines as illustrated and communication transceivers to manage communication with the communication network and a counterpart decoder device. Such elements have been omitted from the foregoing discussion for clarity.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A video coding method, comprising:
given a frame of input video to be coded, searching for match(es) among a plurality of reference frames,
parsing the frame to be coded into a plurality of regions,
deriving a scale factor W for predictive coding by:
for a plurality of pixels in the frame to be coded, developing a system of equations relating a predicted pixel to the pixel in the frame by the scale factor W,
prioritizing equations according to priority among regions, and
solving for the scale factor W;
predictively coding the input frame with reference to matching reference frame(s) using the scale factor W.

2. The method of claim 1, further comprising:
deriving an offset value O for the predictive coding by:
for the plurality of pixels in the frame to be coded, developing the system of equations relating a predicted pixel to the pixel in the frame by the offset value O,
solving for the offset value O from the system of equations, and
wherein the predictively coding also uses the offset value O.

3. The method of claim 2, further comprising,
comparing calculated values of W and O to values of a previously-coded frame, and
when a change in W between the frames differs in direction from a change in O between the frames, then replacing the calculated value of W as a ratio of variances between the frame to be coded and the matching reference frame(s).

4. The method of claim 2, wherein for each pixel Pᵢₙ(i,j) represented by the system of equations is related to the scale factor W and offset value O by:
P_{IN}(i,j)=W*P_{REF}(i,j)+O,
where P_{REF}(i,j) represents a pixel from a matching reference frame that corresponds to pixel Pᵢₙ(i,j).

5. The method of claim 2, further comprising,
comparing calculated values of W and O to values of a previously-coded frame, and
when a change in W between the frames differs in direction from a change in O between the frames, then replacing the calculated value of 0 as a difference in means between the frame to be coded and the matching reference frame(s).

6. The method of claim 2, further comprising, setting the offset value O to zero when the calculated value of O is within a predetermined limit of zero.

7. The method of claim 1, further comprising, setting the scale factor W to one when the calculated value of W is within a predetermined limit of one.

8. The method of claim 1, further comprising, prior to the developing, filtering low texture regions of the frame to be coded and corresponding matching reference frame data.

9. The method of claim 1, further comprising, removing select relation(s) from the system of equations when a difference between respective a pixel to be coded and its predicted pixel are less than a threshold.

10. The method of claim 1, wherein the deriving is performed iteratively in which, after an iteration:
prediction error is estimated between the plurality of pixels and corresponding reference pixels scaled by the scale factor, and
when a prediction error of one of the plurality of pixels exceeds a predetermined threshold, the pixel's corresponding relation is removed from the system of equations for a subsequent iteration.

11. A video coding method, comprising:
given a frame of input video to be coded, searching for match(es) among a plurality of reference frames,
parsing the frame to be coded into a plurality of regions,
deriving an offset value O for predictive coding by:
for a plurality of pixels in the frame to be coded, developing a system of equations relating a predicted pixel to the pixel in the frame by the offset value O,
prioritizing equations according to priority among regions, and
solving for the offset value O;
predictively coding the input frame with reference to matching reference frame(s) using the offset value O.

12. The method of claim 11, further comprising:
deriving a scale factor W for the predictive coding by:
for the plurality of pixels in the frame to be coded, developing the system of equations relating a predicted pixel to the pixel in the frame by the scale factor W,
solving for the scale factor W from the system of equations, and
wherein the predictively coding also uses scale factor W.

13. The method of claim 12, wherein for each pixel Pᵢₙ(i,j) represented by the system of equations is related to the scale factor W and offset value O by:
P_{IN}(i,j)=W*P_{REF}(i,j)+O,
where P_{REF}(i,j) represents a pixel from a matching reference frame that corresponds to pixel Pᵢₙ(i,j).

14. The method of claim 12, further comprising,
comparing calculated values of W and O to values of a previously-coded frame, and
when a change in W between the frames differs in direction from a change in O between the frames, then replacing the calculated value of W as a ratio of variances between the frame to be coded and the matching reference frame(s).

15. The method of claim 12, further comprising,
comparing calculated values of W and O to values of a previously-coded frame, and
when a change in W between the frames differs in direction from a change in O between the frames, then replacing the calculated value of 0 as a difference in means between the frame to be coded and the matching reference frame(s).

16. The method of claim 12, further comprising, setting the scale factor W to one when the calculated value of W is within a predetermined limit of one.

17. The method of claim 11, further comprising, setting the offset value O to zero when the calculated value of O is within a predetermined limit of zero.

18. The method of claim 11, further comprising, prior to the developing, filtering low texture regions of the frame to be coded and corresponding matching reference frame data.

19. The method of claim 11, further comprising, removing select relation(s) from the system of equations when a difference between respective a pixel to be coded and its predicted pixel are less than a threshold.

20. The method of claim 11, wherein the deriving is performed iteratively in which, after an iteration:
prediction error is estimated between the plurality of pixels and corresponding reference pixels scaled by the scale factor, and
when a prediction error of one of the plurality of pixels exceeds a predetermined threshold, the pixel's corresponding relation is removed from the system of equations for a subsequent iteration.

21. A video coding method, comprising:
given a frame of input video to be coded, searching for match(es) among a plurality of reference frames,
parsing the frame to be coded into a plurality of regions,
deriving a scale factor W and an offset value O for predictive coding by:
for a plurality of pixels in the frame to be coded, developing a system of equations relating a predicted pixel to the pixel in the frame by the offset value O, each pixel P_{IN}(i,j) in the plurality related to a corresponding predicted pixel P_{REF}(i,j) by:
P_{IN}(i,j)=W*P_{REF}(i,j)+O,
prioritizing equations according to priority among regions, and
solving for the scale factor W and offset value O;
predictively coding the input frame with reference to matching reference frame(s) using the scale factor W and offset value O.

22. The method of claim 21, further comprising, prior to the developing, filtering low texture regions of the frame to be coded and corresponding matching reference frame data.

23. The method of claim 21, further comprising,
comparing calculated values of W and O to values of a previously-coded frame, and
when a change in W between the frames differs in direction from a change in O between the frames, then replacing the calculated value of W as a ratio of variances between the frame to be coded and the matching reference frame(s).

24. The method of claim 21, further comprising,
comparing calculated values of W and O to values of a previously-coded frame, and
when a change in W between the frames differs in direction from a change in O between the frames, then replacing the calculated value of O as a difference in means between the frame to be coded and the matching reference frame(s).

25. The method of claim 21, further comprising, setting the scale factor W to one when the calculated value of W is within a predetermined limit of one.

26. The method of claim 21, further comprising, setting the offset value O to zero when the calculated value of O is within a predetermined limit of zero.

27. The method of claim 21, further comprising, removing select relation(s) from the system of equations when a difference between respective a pixel to be coded and its predicted pixel are less than a threshold.

28. The method of claim 21, wherein the deriving is performed iteratively in which, after an iteration:
prediction error is estimated between the plurality of pixels and corresponding reference pixels scaled by the scale factor, and
when a prediction error of one of the plurality of pixels exceeds a predetermined threshold, the pixel's corresponding relation is removed from the system of equations for a subsequent iteration.

29. A video coder, comprising:
a coding engine comprising a predictive block-based coder, a motion predictor, a scale unit and an adder,
a reference picture cache, and
a controller, adapted to generate scale factors W and offset values O for weighted prediction by:
given a frame of input video to be coded, searching for match(es) among a plurality of reference frames,
parsing the frame to be coded into a plurality of regions,
deriving a scale factor W and an offset value O for predictive coding by:
for a plurality of pixels in the frame to be coded, developing a system of equations relating a predicted pixel to the pixel in the frame by the offset value O, each pixel P_{IN}(i,j) in the plurality related to a corresponding predicted pixel P_{REF}(i,j) by:
P_{IN}(i,j)=W*P_{REF}(i,j)+O,
prioritizing equations according to priority among regions, and
solving for the scale factor W and offset value O;
wherein, subsequent to calculating W and O for the input frame, the controller supplies the scale factor W to the scale unit and the offset value O to the adder of the coding engine.

30. The video coder of claim 29, wherein the controller, prior to the developing, causes low texture regions of the input frame and corresponding matching reference frame data to be filtered.

31. The video coder of claim 29, wherein the controller,
compares calculated values of W and O to values of a previously-coded frame, and
when a change in W between the frames differs in direction from a change in O between the frames, replaces the calculated value of W as a ratio of variances between the frame to be coded and the matching reference frame(s).

32. The video coder of claim 29, further comprising,
compares calculated values of W and O to values of a previously-coded frame, and
when a change in W between the frames differs in direction from a change in O between the frames, replaces the calculated value of 0 as a difference in means between the frame to be coded and the matching reference frame(s).

33. The video coder of claim 29, wherein the controller, sets the scale factor W to one when the calculated value of W is within a predetermined limit of one.

34. The video coder of claim 29, wherein the controller, sets the offset value O to zero when the calculated value of O is within a predetermined limit of zero.

35. The video coder of claim 29, wherein the controller, removes select relation(s) from the system of equations when a difference between respective a pixel to be coded and its predicted pixel are less than a threshold.

36. The video coder of claim 29, wherein the controller performs the deriving iteratively in which, after an iteration:
the controller calculates a prediction error between the plurality of pixels and corresponding reference pixels scaled by the scale factor, and
when a prediction error of one of the plurality of pixels exceeds a predetermined threshold, the controller removes the pixel's corresponding relation from the system of equations for a subsequent iteration.
